(19) United States
(12) Patent Application Publication
(10) Pub. No.: US 2011/0132181 A1
(43) Pub. Date: Jun. 9, 2011

(54) Wearable Trigger Electronic Percussion Music System

(76) Inventor: Neven Kockovic, Fontenay Aux Roses (FR)

(21) Appl. No.: 12/959,829

(22) Filed: Dec. 3, 2010

Related U.S. Application Data
(60) Provisional application No. 61/267,407, filed on Dec. 7, 2009.

(51) Int. Cl. G10H 3/00

(52) U.S. Cl. 84/723

(57) ABSTRACT

A Wearable Trigger Electronic Music System that can be adopted for simulating any kind of music, anywhere, any time. As for example one can create all the benefits of the percussion instrument such as a drum kit but without the cost and burden of a drum kit. Same also applies to string, wind and other types of instruments of any nation, any culture, any motif, any era any age etc. The system includes all its constituent components including sensors, transducers, electronics, music module, pre-amps and amplifiers, wired or wireless to connections for intra and inter modules including final enjoyment by wired or wireless headphones or speakers. Also delineated is the process of creating music for the DIY enthusiast.

### RELATED DOCUMENT

This application is based upon the provisional application Ser. No. 61/267,407 filed on Dec. 6, 2009 by the same inventor and applicant Neven Kockovic then bearing the title “Wearable Drum Triggers” and the applicant hereby claims priority therefrom.

### BACKGROUND

This invention relates generally to methods, devices and system for creating and enjoying music especially for the DIY musician. More particularly it relates to generating music through donnable garments having plurality of sensors. Even more particularly it relates to creating and playing percussion instruments by using any rigid planar surface in place of an actual drum or drum-kit.

### THE PROBLEM

The problem with prior art Wearable Trigger Electronic Percussion Music Systems is that creation, learning and enjoyment of music is very expensive as most musical instruments are acoustically loud, bulky and expensive and therefore beyond the reach of ordinary people.

### THE SUMMARY

The invention is an improvement over the prior drum kits that allows one to play drums without the cost and logistics of drums or drum-kit. A donnable garment with pressure and trigger sensors creates music, in response to essentially the same hand movements that would be used in striking bongos, or congas or Tablas or similar hand struck musical instruments, including the same feet movements in controlling the open-close Hi-Hat or a bass drum as if on the real drum kit, so as to make the system user or musician transparent.

### PRIOR ART

A preliminary prior art patentability and novelty search was conducted the result of which was that no prior art exists to match the functionality and user friendliness of the present invention. Prior art for the following types of devices was discovered.
a) A glove including sensors on the fingers used for musical keyboard input.
b) A musical instrument including finger sensors and a sound box, all incorporated into a glove.
c) Hand wearable sensors for data entry.
d) Gloves for use as computer game input devices.
e) Gloves for generating MIDI inputs.

Following is a survey of the prior art patents and publications arranged in reverse chronological order for ready reference of the reader.
1) United States Utility Patent Application Publication US 2009/0126554 invented by Xu et al and published on May 21, 2009 for Finger musical instrument.
2) United States Utility Patent U.S. Pat. No. 7,381,884 B1 awarded to Yourik Atakhanian on Jun. 3, 2008 for “Sound Generating Hand Wear”
3) United States Utility Patent U.S. Pat. No. 7,012,593 B2 blessed upon Yoon et al on Mar. 14, 2006 for “Glove-Type Data Input Device and Sensing Method Thereof”
4) United States Utility Patent U.S. Pat. No. 6,819,771 B2 bestowed upon Kenneth Menzies on Nov. 16, 2004 for “Vest with Piezoelectric Transducer for Practicing Music”
5) United States Utility Patent 4,753,146 honorably given to Brock Seiler on Nov. 26, 1986 for “Portable Electronic Drum Set”
6) United States Utility Patent U.S. Pat. No. 6,734,349 B1 honorable given to Conrad Adams on May 11, 2004 for “Fingertip Musical tap Assembly”
7) UK Patent Application invented by and Published in the name of Heping He on 17 Jun. 1998 for inventing “A Keyboard Glove for Use by the Blind”
8) UK Patent Application Publication 2,305,714 invented by Robert Rosenberg published on 16 Apr. 1997 for inventing, “A Keyboard Glove”
9) UK Patent Application GB 2,286,035, invented by Andrew Pendleton and published on 2, Aug. 1995 for “Control Device, e.g. for Computers, with Contacts on the User's Hand”
10) WIPO/PCT Patent Application Publication Number WO 8,912,858 invented by Kadota Katsumi of Japan and published on 28 Dec. 1989 for “Manual Data Input/Output System.
11) United States Utility Patent 4,700,602 earned by Terry Bozzio on Oct. 20, 1987, for “Electronic Drum”
12) United States Utility Patent 4,681,012 invented by Stelma et al and published on Jul. 21, 1987 for “Drummer's Glove”
13) United States Utility Patent 4,635,516 showered upon Giancarlo Giannini on Jan. 13, 1987 for “Tone Generating Glove and Associated Switches”

Prior art search shows that there are many types of electronic gloves, most of which are intended for use in applications other than electronic music or more specifically electronic percussion. This opinion is based on the assumption that one of ordinary skill in the prior art, who is familiar with electronic music input devices, would look to the use of electronic gloves in other fields, such as data entry. One of ordinary skill in the art would not be expected to attempt to use an electronic glove to generate inputs to an electronic music interface, such as a drum module. To the extent that prior art electronic gloves would function in this manner is non-obvious, it appears to be prima facie patentable, without more.

The additional feature that is believed to distinguish the invention at bar is percussion e-loops, e-caps and e-gloves of this invention over this prior art is the use of a percussion sensor in the palm or the glove to generate a bass sound so that a hand percussionist can employ normal hand percussion movements to electronically generate music by striking any surface in substantially the same way that he would strike an acoustic drum.

Admittedly, a number of prior art data entry patents include sensors that are located somewhere in the palm area. However, none of these prior art patents employ a palm sensor as a hand percussion input or as an input that operates separately from other sensors on the glove. The one patent that does employ a palm sensor to contact a surface other than another sensor on the glove is used with a surface that is wired to the palm sensor as shown in UK Patent Application GB 2 286 035. That device cannot be employed to generate an electronic signal by striking any convenient planar hard or rigid surface.

U.S. Pat. No. 7,381,884 is probably the closest prior art reference to the e-glove device. Although this patent does employ a sensor located generally in the palm area, that palm sensor is only used in conjunction with other finger sensors and is not used as a direct input to strike any surface for the purpose of generating a bass sound, of the type generated by the normal hand movement of a hand percussionist in striking an instrument, such as bongos, congas, Tablas etc.

The presence of a palm sensor for generating a bass input, would not limit the commercial use of an e-glove or e-ring apparatus to hand percussion. The user could choose to use it for other purposes. For instance, a user could still use the glove for generating other inputs, such as striking a surface in a manner intended to generate sounds corresponding to striking a drum with drum sticks or striking cymbals. However, based on inventor's perception of the prior art, the bass palm sensor is prima facie non-obvious. There are other features that support patentability. It has been assumed that essentially the same functions could be performed with either the e-gloves or the e-rings. Admittedly it might be easier to use the e-rings to generate percussion sounds for an acoustic drum set including a bass drum, snare drums Tom Toms and cymbals.

However, it is applicant's position that the e-glove can also be used for this purpose. The inventor also teaches the use of sensors on the percussionist feet or on other parts of the body. There is scant prior art if any for such features. The means of securing the device to the body is also unique, because alternative ways of strapping the sensors to the body are included which are not found in prior art or are easily distinguishable over the prior art. The connections employed in the embodiments disclosed in inventors Provisional Patent Application entitled, “Wearable Drum Triggers” and the prototypes, demonstrate novelty over the prior art.

It is essential to employ stereo plugs attached to a bracelet for stereo applications. Wireless communication as an alternative to wired embodiment has been addressed as a contributory ground of patentability, notwithstanding such wireless communication is shown in the prior art for other remotely or tangentially related applications.

It is the applicant and his counsels' considered professional opinion that the wearable electronic percussion music system of this invention is patentable over the prior art uncovered in the search.

### DISCUSSION OF PRIOR ART

### A Glove Including Sensors on the Fingers Used for Musical Keyboard Input

U.S. Pat. No. 5,119,709 and related patents assigned to Yamaha are representative of prior art that employs pivotal or flexible glove sensors to detect the flexure of the wearer's fingers. This signal is used to generate an initial touch response, such as the velocity of movement of the finger, before an actual touch. The initial touch signal along with an after touch signal and a key on signal can be transmitted to an electric organ, synthesizers or similar keyboard device. These signals can be used by dancers, etc. to generate more complete musical sounds based on body movements.

Such a flex sensor, as opposed to a pressure sensor such as a piezoelectric sensor, would not appear to be suitable for use by a hand percussionist so that a signal would be generated when a surface is struck. Furthermore, such flex sensors would appear to be much more complicated. Significantly the flex sensor used on these Yamaha devices would appear to be incompatible with a palm sensor. Other examples of these Yamaha devices are shown in U.S. Pat. No. 5,512,703 and U.S. Pat. No. 5,338,891, among others.

### A Musical Instrument Including Finger Sensors and a Sound Box, all Incorporated Into a Glove.

U.S. Pat. No. 7,381,884 is probably the closest prior art reference to the e-glove embodiment that found in the search. This patent discloses a glove with separate sensors on each finger, including on the knuckle in addition to the fingertips. Palm sensors are also employed. Unique signal patterns of each of the signals from these sensors result in specific audible sounds. Speakers are mounted on the gloves and the potentiometers are used as sensors. A digital signal processor on the glove can be programmed to recognize the unique patterns. Although the sensors located near the ends of the fingers appear to be intended to create musical and rhythmic patterns by tapping their fingers on any suitable surface, the sensors located near the knuckles and in the palm regions appear intended to be contacted by the sensors near the ends to “modify the audible musical sounds” so that the user can “create a wide range of notes, rhythms and/or melodies” with the glove. The knuckle and palm sensors thus appear to be essentially “function keys” and are not intended to be used to tap or strike a surface as would the palm contact of applicant's music system. There is no suggestion let alone teaching in the prior art that the palm sensor be used as a bass input for drums.

A Japanese patent application filed under the Patent Cooperation Treaty and published as WO1988JP01257 also employs what appears to be a pressure sensor on the heel of the palm of a glove. Only a one paragraph English abstract is available, since the application was published in Japanese, and there do not appear to be any English language or other equivalent translations. This patent application does appear to be distinguishable from the e-glove invention because inputs are generated by touching sensors located on the fingers to other sensors located on the glove, and this does not appear to be a device that is used to generate signals by touching or striking other objects.

US Published Patent Application 2009/0126554 discloses a glove with fingertip keys connected to sound boxes located on the backside of a glove. The glove also includes range selection switches located on the glove heel that give a greater octave range. The fingertip sensors employed in this invention appear to be located on the back of the fingers at the tips and not on the interior surface that would strike a surface as part of a percussion stroke.

U.S. Pat. No. 4,635,516 shows a switch that can be used at the finger joints in a glove in which a contact is made when the fingers flex about the joints. The switches appear to be located on the backside of the gloves instead of on the inside, and this glove can include an AM or FM transmitter.

UK Patent Application 2 221 557 shows glove musical instrument in which four finger contacts, in the form of spring members are connected to a speaker of piezo buzzer on the back of the gloves.

### Hand Wearable Sensors for Data Entry.

A large number of prior art patents show glove type devices that are used for computer keyboard input or data entry.

U.S. Pat. No. 5,581,484 discloses a glove having fingertip pressure sensors, such as piezoelectric sensors, and acceleration sensors. These sensors can be used for computer or keyboard input.

U.S. Pat. No. 7,012,593 discloses an input glove that includes sensors located at the fingertips. The switches can operate in a digital or analog mode. An analyzer determines input data by analyzing the sensing signal. Once the input signal in determined by the analyzer, the input signal outputs the determination signal to an external terminal. For example, digital inputs can be generated in response to a combination of simultaneously pressed sensors, the number of sensors pressed, the duration of sensor pressing or the pressure applied to sensors. Typically inputs can be generated by touching two sensors (i.e. two fingers) together. Thus the individual finger sensors do not appear to act independently.

Another data input glove is shown in UK Patent Application GB 2 286 035, which shows a glove having contact sensors located on the thumb and fingers of a hand, as well as a sensor located on the palm heel of the hand. The contact sensors employed in this device are intended to close a circuit when contacted with a conductive surface on a separate pad. Thus this device is not intended to generate a signal when striking any surface, such as the e-glove/e-ring invention. It is unclear whether the palm sensor is located in a position that would be suitable for use by a hand percussionist. The only relevant disclosure of this patent application is that a sensor may be located on the inside of the hand at a point spaced from the fingers. Clearly this device would not be used to generate a signal by striking a blow.

U.S. Pat. No. 4,414,537 discloses a data entry glove having proximity touch sensors located on the fingertips. This patent also shows a knuckle bend sensor that can be located at the knuckle of the index finger and extending into the palm region. This is not a touch or percussion impact sensor. However, one embodiment of this glove employs a touch sensor at the base of the ring finger at a position that appears to be along the raised surface at the top of the palm. This touch sensor is however intended to be activated by the thumb, and would not appear to comprise a sensor for detecting strikes by the hand.

U.S. Pat. No. 5,581,484 shows finger mounted device for computer input. The sensors mounted on the tips of the fingers appear to be accelerometers.

UK Patent Application GB 2 305 714 discloses a keyboard glove in which finger sensors are located on the palm side of the fingertip of the glove is approximately the same position as the finger sensors in e-glove.

This keyboard entry device is intended to function as a chord keyboard, a special data entry keyboard that uses fewer keys than a QWERTY keyboard. It has shift or function sensor keys located along the side of the index finger, but does not include any keys or sensors in the palm as in the e-glove or e-ring device.

A specialized data entry device is shown in UK Patent Application GB 2 320 315, which shows a glove with sensors that generate signals in response to the hand position code used by blind people. Between 45 and 47 push buttons on each glove are located on each finger and in the palm area, so that when touched by fingertips, which extend beyond the glove, according to the standard hand position code, an appropriate signal is transmitted to a computer. This is explicitly a soft touch device. The only relevant teaching of this patent application is that sensors can be located on the palm. However multiple soft touch palm sensors are employed and it would not seem plausible that a glove of this type could be used by hand percussionist, nor would this device suggest the e-loops, e-ring or e-glove embodiments.

### Gloves for Use as Computer Game Input Devices.

U.S. Pat. No. 4,613,139 discloses a glove with electrical contacts located on the fingers and the thumb for generating inputs to a joystick control port. Signals appear to be generated by touching the thumb to one of the fingers.

### Gloves for Generating MIDI Inputs.

There appear to be a number of Internet postings that discuss gloves suitable for MIDI inputs. An example of an item termed a Wireless MIDI glove using flex sensors and a series of wires leading to what appears to be a wireless transmitter is shown at http://vipre.uws.edu.au/tiem/?p=605.

The search on which this opinion is based shows that there are many types of electronic gloves, most of which are intended for use in applications other than electronic music or more specifically electronic percussion. This opinion is based on the assumption that one of ordinary skill in the prior art, who is familiar with electronic music input devices, would look to the use of electronic gloves in other fields, such as data entry. One of ordinary skill in the art would be expected to attempt to use an electronic glove to generate inputs to an electronic music interface, such as a drum module. To the extent that prior art electronic gloves would function in this manner, it then appears that an electronic glove providing inputs to a drum interface would be patentable, without more.

The additional feature that is believed to distinguish Neven Kockovic's percussion e-glove or e-ring embodiments for sensors over this prior art is the use of a percussion sensor in the palm of the hand to generate a bass sound so that a hand percussionist can employ normal hand percussion movements to electronically generate music by striking any surface in substantially the same way that he would strike an acoustic drum, which makes it user friendly and user transparent in shifting from music instruments to sensor equivalent embodiments.

Admittedly, a number of prior art data entry patents include sensors that are located somewhere in the palm area. However, none of these prior art patents employ a palm sensor as a hand percussion input or as an input that operates separately from other sensors on the glove. The one patent that does employ a palm sensor to contact a surface other than another sensor on the glove is used with a surface that is wired to the palm sensor as shown in UK Patent Application GB 2 286 035. That device cannot be employed to generate an electronic signal by striking any convenient surface.

The presence of a palm sensor for generating a bass input, would not limit the commercial use of an e-glove or e-ring apparatus to hand percussion. The user could choose to use it for other purposes.

For instance, a user could still use the glove for generating other inputs, such as striking a surface in a manner intended to generate sounds corresponding to striking a drum with drum sticks or striking cymbals. However, based on my current perception of the prior art, the bass palm sensor would still need to be included in the glove or as part of a ring assembly, in order to obtain patent protection.

There are other features that support patentability. It is applicant's position that same functions cannot be performed with either the e-gloves or the e-rings. Admittedly it might be easier to use the e-rings to generate percussion sounds for an acoustic drum set including a bass drum, snare drums and cymbals. However, it would appear that the e-glove could also be used for this purpose. The use of sensors on the percussionist feet or on other parts of the body is totally non-obvious. There is no prior art for such features.

The connections employed in the embodiments disclosed in Neven's Provisional Patent Application entitled Wearable Drum Triggers” from which this application claims priority are also non-obvious over the prior art.

Wireless communication as an alternative to cables is an additional non-obvious feature such that the system as a whole is non-obvious even if any one component of the system is found to be obvious when considered alone. So in the opinion of the applicant the context of system as a whole is what makes the invention non-obvious over prior art and therefore prima facie patentable.

Accordingly none of the prior art devices singly or even in combination provides all of the features and objectives established by the inventor for this system as enumerated below.

### OBJECTIVES

1. It is an objective of this invention to provide methods, devices and system for creation and enjoyment of music simulated with plurality of sensors and music module.
2. Another objective of this invention is that music of any musical instrument can be synthesized, created or otherwise generated LIVE and in real time.
3. Another objective of this invention is to embed sensors in a variety of wearable garments inter alia, loops, bands, straps, rings, caps, and gloves etc.
4. Another objective of this invention is that the plurality of sensors of many types can be housed in many types of donnable or wearable garments on any limb or part of the body such as fingers, hand, palm, arm, toes, feet, ankle, elbow even head, back or other limbs of a music enthusiast or just about anyone with curiosity or interest or aptitude in music.
5. It is therefore an object of the present invention to provide a new and improved system which has all the advantages of the prior art but none of the disadvantages of the prior art.
6. An even further object of the present invention is to provide a new and improved system which is susceptible to low cost of manufacturing with regards to materials, labor and burden. The savings thus resulting from it can be passed on to which in turn to the consuming public.
7. Another objective of this invention is that the user does not have to depend on the playing surfaces, but he or she can use any hard planar surface to produce the sound, because the user wears the sound transducers with the certain carriers.
8. Another objective of this invention is that it is light weight with small foot print and small size, volume such that is extremely portable and could be played where normally other percussion instruments could not fit and be used while traveling in a bus or aircraft for example.
9. Another objective of this invention is that all types of users regardless of age, size, musical aptitude or lack thereof can use the system to learn, create and enjoy all types of musical instruments, without the hassle and cost of musical instruments.
10. Another objective of this invention is that it is extremely quiet (almost soundless and soundproof) as contrasted from conventional electronic drums and equipment whose natural body acoustics and body size (plus construction of theirs playing surfaces) still give a quite loud acoustic sound response.
11. Another objective of this invention is that it work in both mono and stereo mode with high fidelity.
12. Another objective of this invention is that certain sound transducers give different levels of sensibility so one can by using them achieve very realistic touch when playing instruments like piano over the midi device, unlike prior art piano gloves (the toy for the children) that are made with an ON-OFF switches and have no feedback touch sensitivity.
13. Another objective of this invention is that it work with a wide variety of sensors, including pressure, trigger, force sensor resistors, gyroscopes, accelerometers etc. to allow the musician to preserve his or her original percussion playing technique on his or her original percussion instrument.
14. Another objective of this invention is the ability to play the percussion or drum sounds and technique, or a piano sound and the technique without having to depend on the playing surfaces of those respective actual instruments.
15. Another objective of this invention is that the player preserves and enhances his or her playing technique while playing electronically (for example Congas, bongos or Tablas and other percussion players)
16. Another objective of this invention is that it permits the user to create drum patterns, rhythms, compose with some other instruments while using midi equipment and Virtual Studio Technology (VST)
17. Another objective of this invention is that the wearable sensor garment is easy to don on and easy to take off.
18. Another objective of this invention is that one can wear any or all of the pieces in any combination he or she wishes.
19. It is another object of the present invention to provide new and improved system which may be easily and efficiently manufactured and marketed.
20. It is further object of the present invention to provide a new and improved system which is safe and long lasting.
21. Another objective of this invention is to provide aesthetic and elegant design that integrates harmoniously with the environment.
22. Another objective of this invention is having that function embedded and be intuitive as well as clearly visible when enabled.
23. Another objective of this invention is that it uses little or no additional power or energy.
24. Another objective of this invention is that it is easy to use even intuitive that requires little additional training if any.
25. Another objective of this invention is that it is easy to learn and teach to preserve and enhance music skills of self and others.
26. Another objective of this invention is that it be environmentally friendly.
27. Another objective of this invention is that it be made of modular standard parts easily interface-able to each other.
28. Another objective of this invention is that it meets all federal, state, local and other private standards, guidelines and recommendations with respect to safety, environment, and quality and energy consumption.
29. Another objective of this invention is that it be suitable for users of all types including users of different cultures, languages, ages, gender, nations and races etc.
30. Another objective of this invention is that it be elegantly simple in concept and design.
31. Another objective of this invention is that it be used by handicapped as well as novice and amateur musicians.
32. Another objective of this invention is that it be easy to assemble, service, transport and store.
33. Another objective of this invention is that it be useable in all types of locations including home, schools, work, office, shop floor, factory floor, transit etc 34. Another objective of this invention is that it can be used with thin insulating gloves in cold environment without any degradation in speed, quality or performance.
35. Another objective of this invention is that the musician experiences normal look, feel, and touch with tactile feedback.
36. Another objective of this invention is that it be user friendly and independent of hardware and software transparent.
37. Another objective of this invention is that it lends itself to multiple uses.
38. Another objective of this invention is that it be reliable such that it practically never fails and requires little or no maintenance.
39. Another objective of this invention is that it be made from biodegrade materials to the extent practical and cost effective.
40. Another objective of this invention is that it be long lasting with high MTBF (Mean Time Between Failures) made from durable materials.
41. Another objective of this invention is that it have lower life cycle cost.
42. Another objective of this invention that it can accent and complement any kind of environment anywhere.

Other objectives of this invention reside in its simplicity, elegance of design, ease of manufacture, service and use and even aesthetics as will become apparent from the following brief description of the drawings and the detailed description of the concept embodiment.

These together with other objects of the invention along with the various features of novelty which characterize the invention, are pointed out with particularity in the claims annexed to and forming a part of this disclosure. For a better understanding of the invention, its operating advantages and the specific objects attained by its uses, reference being made to the accompanying drawings and descriptive matter in which there is illustrated preferred embodiment and alternate embodiment(s) of the invention.

There has thus been outlined rather broadly, the more important features of the invention in order that the detailed description thereof that follows may be better understood and in order that the present contribution to the art may be better appreciated. There are of course, additional features of the invention that are described hereafter and which form the subject matter of the claims appended at the end of the specification

### BRIEF DESCRIPTION OF THE DRAWINGS

Following is a brief description of the several views of the drawings complete with reference numerals wherein last two least significant digits represent the item (not necessarily tangible) number and the left most one or two digits represent the figure number.

FIG. 1 is a pictogram of a musician sitting on a stool, creating and enjoying the music with the modules and accessories of the Wearable Trigger Electronic Percussion Music system of this invention interconnected and interfaced including a variety of wearable and/or donnable garments with embedded sensors, music module, electronics module pre-amplifiers and amplifiers, wired headphones, loudspeakers with wireless interface option.

FIG. 2-A is a block diagram of the system showing a piezo pressure sensor/transducer, pre-amp and music module, electronic connection device, amplifier, as well as wired head phones and loud speakers.

FIG. 2-B shows a wireless embodiment of block diagram of FIG. 2-A shown complete with a piezo pressure sensor/transducer, pre-amp and music module, electronic connection device, amplifier, as well as wireless transmitters and wireless receivers, head phones with wireless interface and loud speakers also with wireless interface.

FIG. 3-A shows the palm side of a hand with a plurality of sensors on fingers, palm of the hand, a force sensor resistor at the base of the palm, and a bracelet for facilitating connections from sensors to pre-amp, electronics and music module.

FIG. 3-B shows left foot with wireless transmitter and concomitant interface. The right foot generally includes one or more sensors for tapping etc.

FIG. 4 is shows show a sensor on a strap or band which is used with eye and hook VELCRO® (a fibrous fastener) to form a loop or band around a finger, palm or foot. The FIG. 4 shows this operation in 3 steps as follows.

FIG. 4-A shows the sensor being placed on a loopable strap as it has on top of an one end Hook fibrous fastener and on the underside of the other end matching Eye fastener(s) also known by its trademark name of VELCRO®

FIG. 4-B shows the sensor and a connector with male end connected to the sensor and the female end female for mounting on the bracelet on the wrist of the musician of FIG.-1 for example.

FIG. 4-C shows the looped strap with sensor and connector ready for mounting the palm to receive and house the sensor and the wrist to receive the bracelet on which is mounted the connector for further connecting to a pre-amp or music module or electronics module as needed and deemed appropriate.

FIG. 5-A shows the arm of a musician with the sensor mounted on the elbow which is easily activated by hitting the elbow on any hard planar surface. The sensor can also be a pressure sensor or force sensor resistor instead of the tactile switch such that it is not necessary to hit the elbow against a planar surface as the sensor can be activated by pushing against a planar surface instead of impact hit. It is a sensor primarily for pressing and secondarily for hitting. This is analogous to the original natural movement that most percussionists are used to bend or stretch the skin of the playing surface to modulate the acoustic pitch and/or sound.

FIG. 5-B depicts the mounting of a sensor on the heel of the right foot so that the left foot is free to house a wireless transmitter interface if one is desired.

FIG. 6 delineates the location of sensor on a finger with a finger cap instead of the loop of FIG. 4 where in more specifically FIG. 6-A shows the hand with the finger caps and sensors at the tips and wired connection to a connector mounted on the bracelet on the wrist of the musician. More specifically delineated are thumb 651, index finger 652, middle finger 653, ring finger 654, and little finger 655 under the detailed description which follows this brief description of the drawings. FIG. 6-B shows in greater detail the finger cap, sensor, connector and a wired connection between the sensor and the music module. The male and female connectors may be interchanged without nay degradation in performance with the aid of convertors which can convert one kind of connector male or female to the other type.

FIG. 7-A shows the glove embodiment with plurality of sensor(s) one for each finger, a sensor on the palm and a bracelet on the wrist for facilitating connection for music module which is shown further with interface to amplifier, speaker, head phones etc. Additionally and a force sensor resistor (not shown) on the base of the palm similar to 360 of FIG. 3-A can also be incorporated.

FIG. 7-B shows the back side of the Glove of FIG. 7-A

FIG. 8 shows the protocol for playing the cymbal creation and snubbing (arresting, stopping halting, interrupting, choking muting or the like) effect like a LIVE conductor would do in a concert except here it is done with only one hand and that too without any orchestra, wherein more particularly

FIG. 8-A shows a perspective view of a hand in partially fisted (and hence partially open also) position. This figure also shows two sensors, a pressure sensor positioned on the outside of the thumb for initiating the cymbal sounds and a tactile switch positioned on the underside of the thumb such that if a fist is made then the contact of the thumb sensor with the index finger triggers this sensor to arrest the sound of the cymbal suddenly, abruptly and sharply.

FIG. 8-B shows the two sensors on a loopable band with a Piezo pressure sensor on the left side of the band or strap and the tactile sensor switch on the right side of the same band and the two wires are connected to a connector which for ease of connection is male on both ends for the right hand cymbal operation.

FIG. 8-C shows the same strap of FIG. 2-B shown curved as it will be looped around the thumb such that the piezo pressure sensor ends up on the outside of the right hand thumb and the tactile trigger on the underside of the thumb also for the right hand cymbal operation.

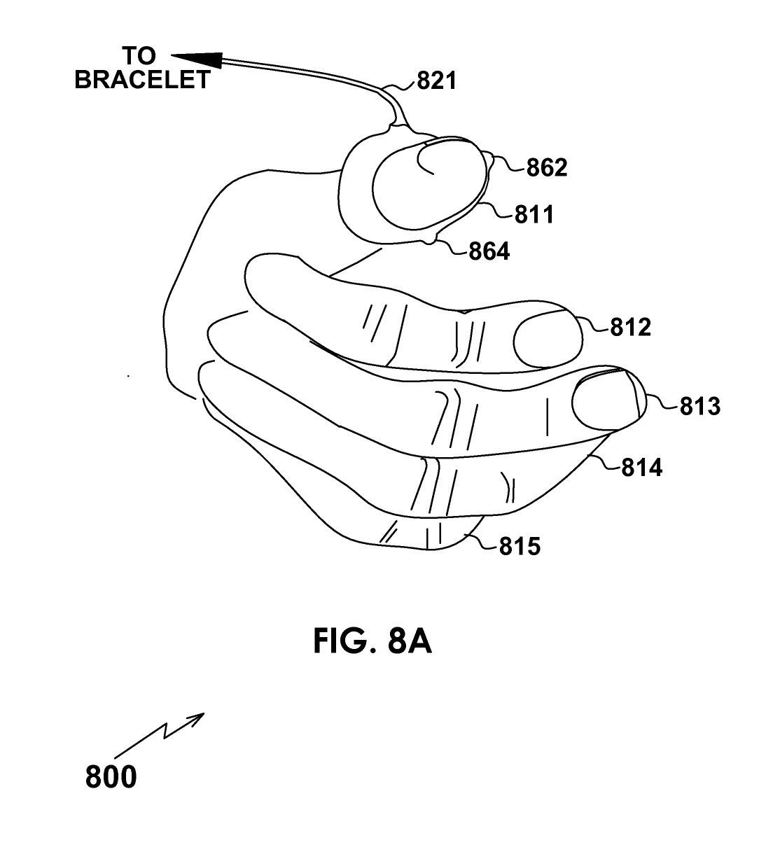

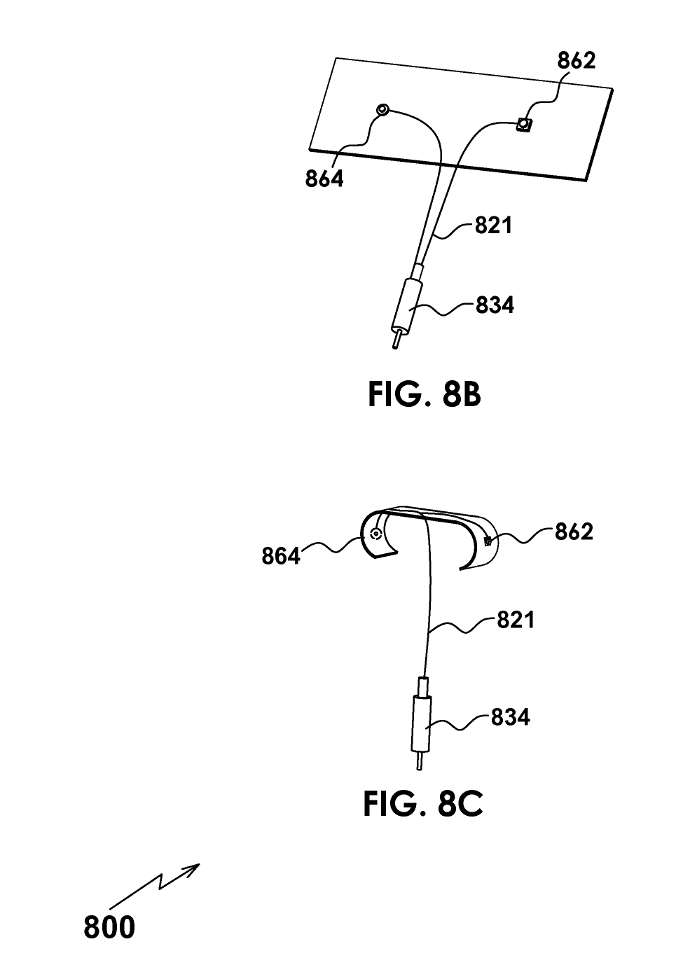

In FIGS. 8-B and 8-C naturally for the left hand cymbal operation the sensors positions on the band are reversed because left and right hands are mirror images of each other.

### DETAILED DESCRIPTION OF THE BEST MODE OF THE PREFERRED EMBODIMENT

The Wearable Trigger Electronic Percussion Music System of this invention as shown in the several views of the drawings wherein like numerals represent like parts in various views of the drawings complete with reference numerals wherein last two least significant digits represent the item (not necessarily tangible) number and the left most digit represent the figure number. In this respect explaining at least one embodiment of the invention in detail, it is to be understood that the invention is not limited in its application to the details of construction and to the arrangements of the components forth in the following description or illustrated in the drawings. The invention is capable of other embodiments and of being practiced and carried out in various ways. Also it is to be understood that the phraseology and terminology employed herein are for the purpose of descriptions and should not be regarded as limiting their scope.

As such those skilled in the art will appreciate that the conception, upon which this disclosure is based, may readily be utilized as a basis for the designing of other structures, methods devices and systems for carrying out the several purposes of the present invention. It is important therefore, that the claims be regarded as including such equivalent constructions insofar as they do not depart from the spirit and scope of the present invention.

Further, the purpose of the abstract appended at the end of the specification is to enable the U.S. Patent and Trademark Office and the public generally, and especially the scientists engineers and practitioners in the art who are not familiar with patent of legal terms or phraseology to determine quickly from a cursory inspection the nature and essence of the technical disclosure of the application.

The abstract is neither intended to define the invention or the application of the invention to various relevant parts which is measured by the claims, nor is it intention of the applicants to limit intended the scope of this invention in any way.

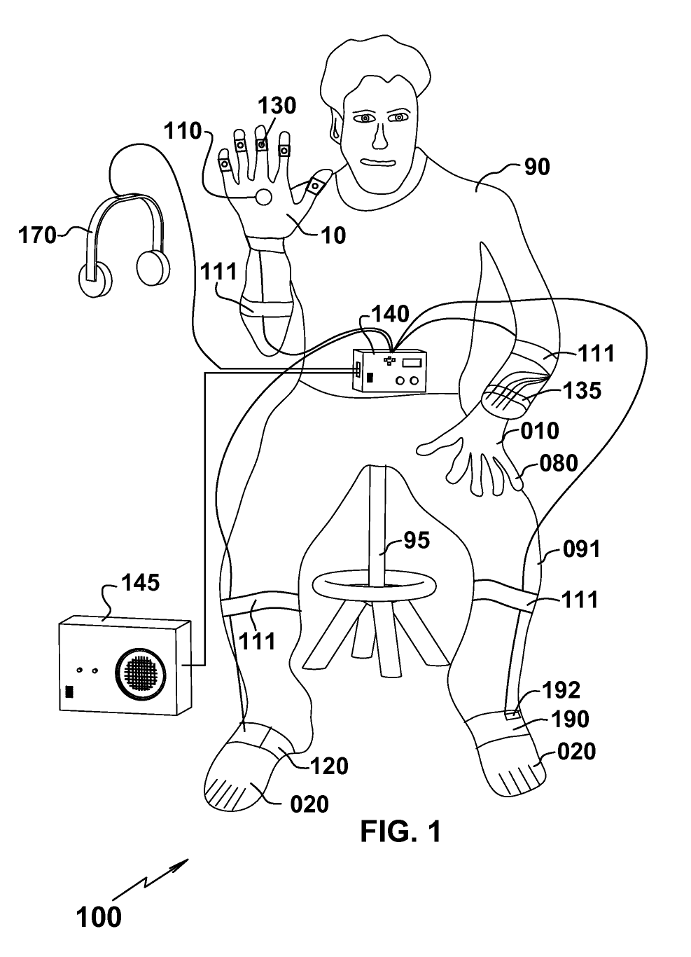

FIG. 1 is a pictogram of a musician sitting on a stool, creating and enjoying the music with the modules and accessories of the Wearable Trigger Electronic Percussion Music system of this invention interconnected and interfaced including a variety of wearable and/or donn-able garments with embedded sensors, music module, electronics module pre-amplifiers and amplifiers, wired headphones, loudspeakers with wireless interface option. It is shown complete with Glove 80 on the left hand and palm sensor 110 and loop sensors 130 on the fingers of the right hand of the Musician 90 seated on Stool/Chair 95. Also shown are modules with logic and power ground 99, Hand/Palm Sensor and Loop 110, Foot Sensor and Loop 120, Finger Sensor support with loop, strand, band, ring, cap 130, Interconnection Module generally mounted on a bracelet worn on the wrist 135, Electronics and Music module 140, Amplifier 145, and plurality of sensor 160.

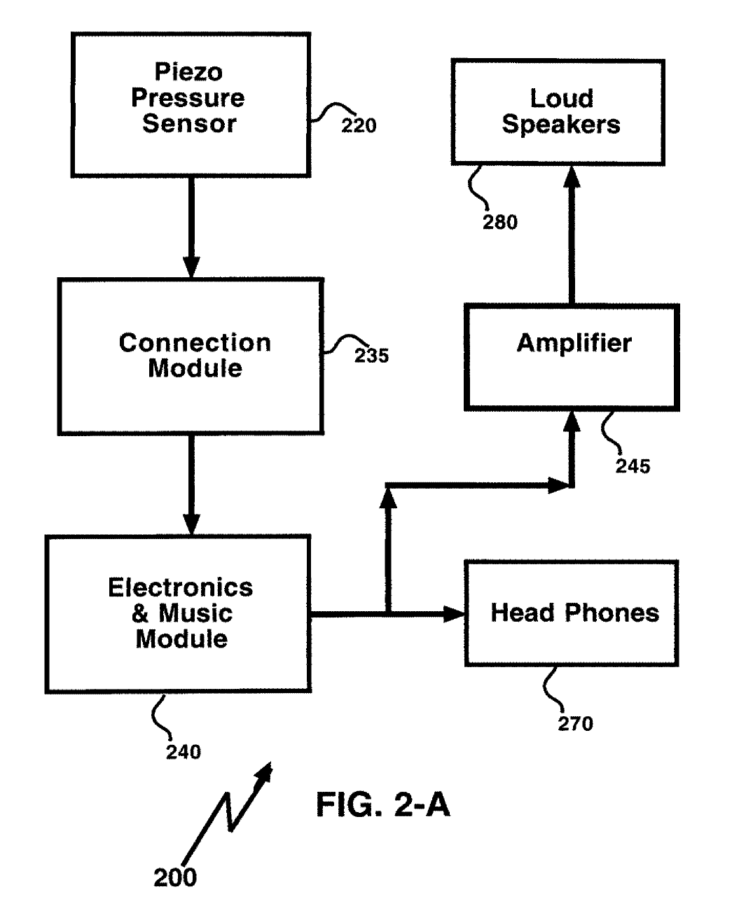

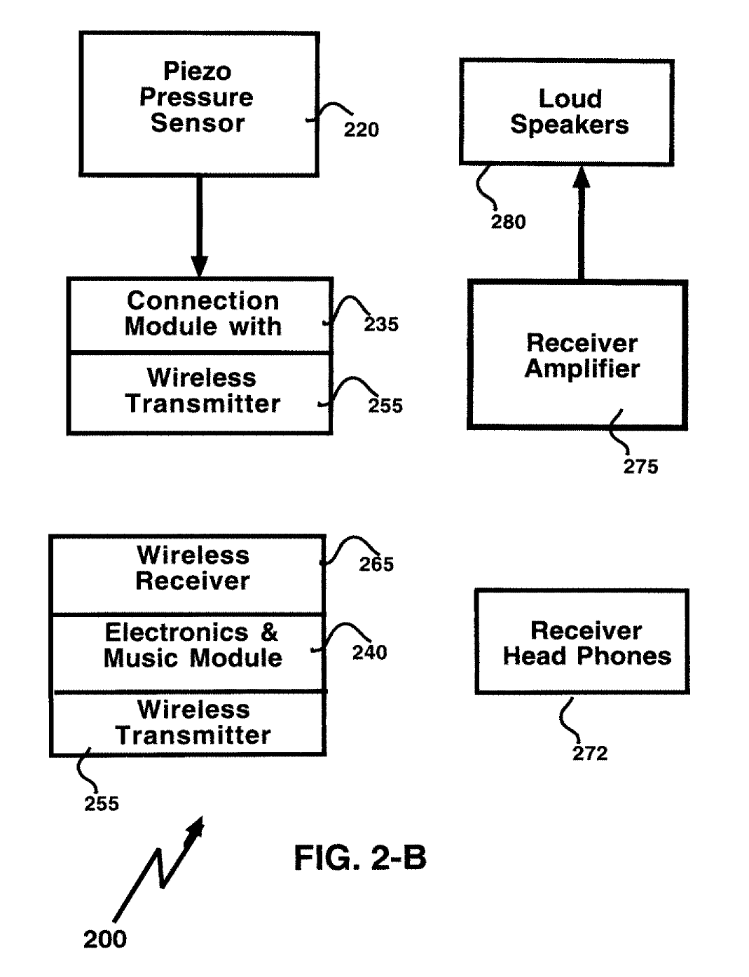

FIG. 2-A is a block diagram of the system showing a piezo pressure sensor/transducer, pre-amp and music module, electronic connection device, amplifier, as well as wired head phones and loud speakers. The block diagram is shown complete with a Piezo pressure transducer 220, Interconnection module configured on a bracelet 235, Music module 240, Amplifier 245, Wireless Transmission Interface 255, Wireless Receiver Interface 265, Headphones with wireless receiver interface 272, Loud Speakers with wireless receiver interface 275.

### Wireless Embodiment Option

FIG. 2-B shows a wireless embodiment of block diagram of FIG. 2-A shown complete with a piezo pressure sensor/transducer, pre-amp and music module, electronic connection device, amplifier, as well as wireless transmitters and wireless receivers, head phones with wireless interface and loud speakers also with wireless interface. Thus it is a block diagram of the wireless connection as an option to the cable connection. It shows the connective sequence using the wireless connection between the elements. Any type of the wireless connection can be used. It's a design parameter choice best left to the design engineer.

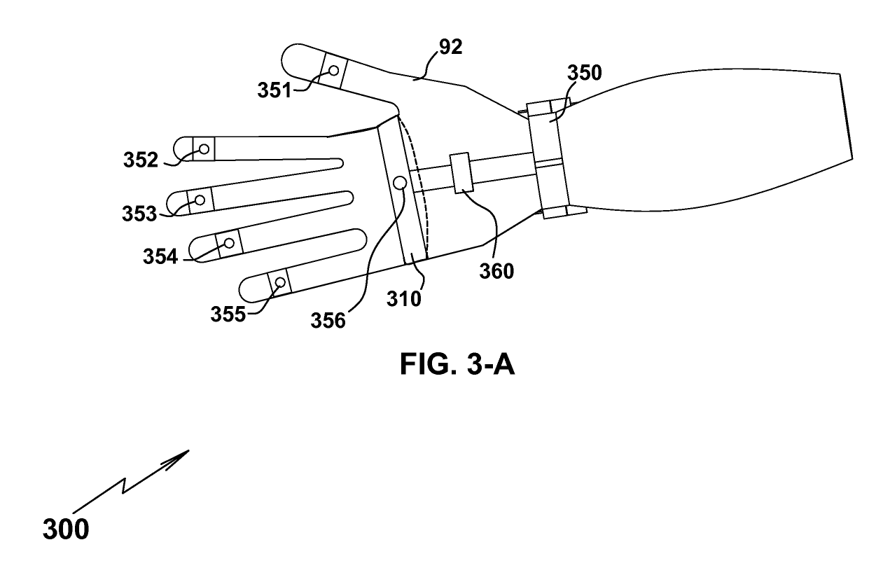

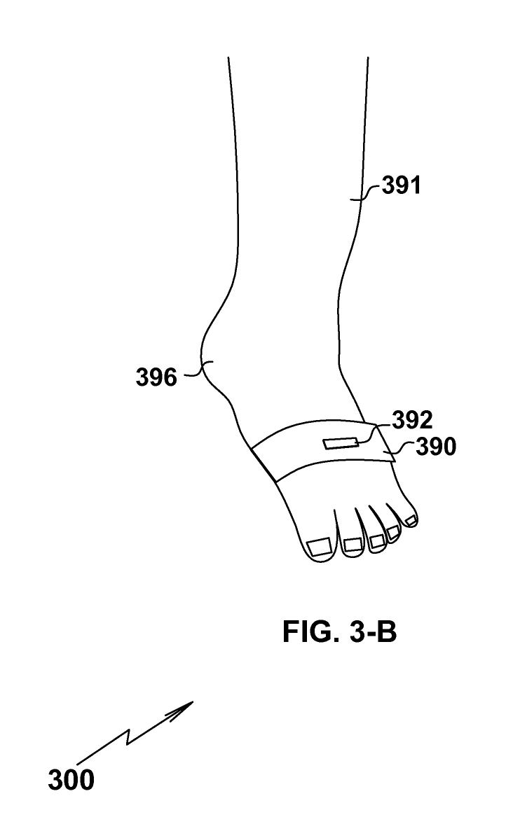

To provide even greater degree of mobility ‘Blue-Tooth’, mobile phones or smart phones interface may be employed notwithstanding in the preferred embodiment of the best mode the inventor employed all modules wired or all wireless with autonomous transmitter and energy source as mixing the two is not desirable Essentially a Piezo transducer or some other sound pressure transducer to electronic voltage signal is connected to the proper electronic connective device such as the bracelet (Shown in FIGS. 1, 3 6 & 7) with a wireless transmitter (that runs on batteries) which transmits the signal or the information further to the wireless receiver which is a part of a drum module or some other sound module or other appropriate musical equipment.

After receiving the signal or the information one further sends the sound, sound signal or the information with the wireless transmitter instead of cable to be picked up by the receiver of the headphones or the amplifier intended to be used.

The state of the art wireless interfaces are miniature enough that they can be easily used for transmission of sensor signal wirelessly to the nearest module in close range of a few feet or the range may be extended with amplification.

The wireless option works the same way for the heel carrier, elbow carrier, finger caps, palm strap carrier, foot carrier and gloves embodiments. It is also contemplated by the inventor that hybrid wired and wireless environments may be employed although in the preferred embodiment of the best mode the inventor employed all modules wired or all wireless with autonomous transmitter and energy source as mixing the two is not desirable though technically possible and even desirable under some exceptional circumstances.

FIG. 3 shows hand and foot embodiment. More particularly FIG. 3-A shows the palm side of a hand with a plurality of sensors on fingers, palm of the hand, a force sensor resistor at the base of the palm, and a bracelet for facilitating connections from sensors to pre-amp, electronics and music module. FIG. 3-B shows left foot with wireless transmitter and concomitant interface.

The right foot generally includes one or more sensors for tapping etc. The FIG. 3 is shown complete with Foot Loop wireless interface 320, Wireless Interface on Foot Loop 322, Male connector 334, Inter Connection Bracelet or Module 335, Female connector 336, Music module 340, Amplifier 345, Force Sensor Resistor and support 350, in the palm of hand 330, Thumb sensor and support 351, Index Finger sensor and support 352, Middle Finger sensor and support, 353, Ring Finger sensor and support 354, Little Finger sensor and support 355, Sensor in palm or arch of foot 356, Glove 380, Leg of musician 394 Let Foot of musician for wireless interface 396.

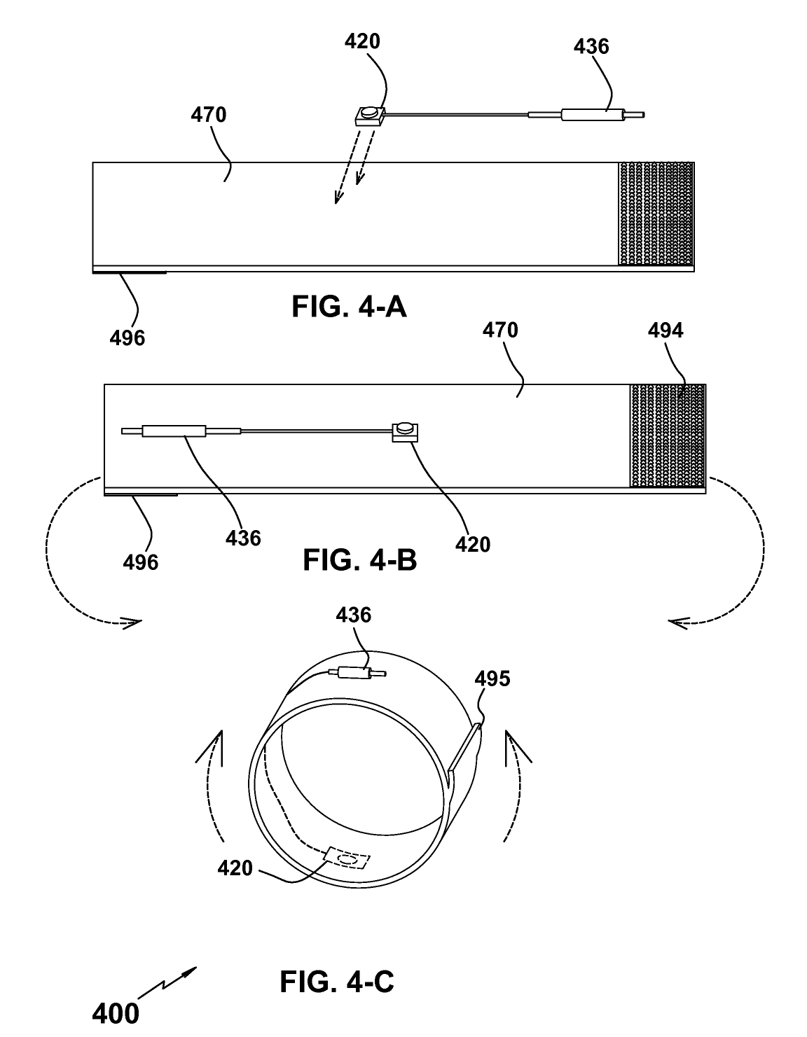

FIG. 4 is shows show a sensor on a strap or band which is used with eye and hook VELCRO® (a fibrous fastener) to form a loop or band around a finger, palm or foot. It is shown complete with Piezo pressure sensor 420, interconnector 436, Band Loop or strap 470, used as sensor support, Hook Velcro® 494, Fastener generally eye and hook matching type 495, Eye Velcro® 496 Sub FIGS. 4-A, 4-B, 4-C of FIG. 4 show this operation in 3 steps as follows.

FIG. 4-A shows the sensor being placed on a loop-able strap as it has on top of an one end Hook fibrous fastener and on the underside of the other end matching Eye fastener(s) also known by its trademark name of VELCRO®

FIG. 4-B shows the sensor and a connector with male end connected to the sensor and the female end female for mounting on the bracelet on the wrist of the musician of FIG.-1 for example.

FIG. 4-C shows the looped strap with sensor and connector ready for mounting to receive and house the sensor and the wrist to receive the bracelet on any suitable limb and any suitable mounting means the for further connection to a pre-amp or music module or electronics module as needed and deemed appropriate. The loop is suitable for any type or size of limb.

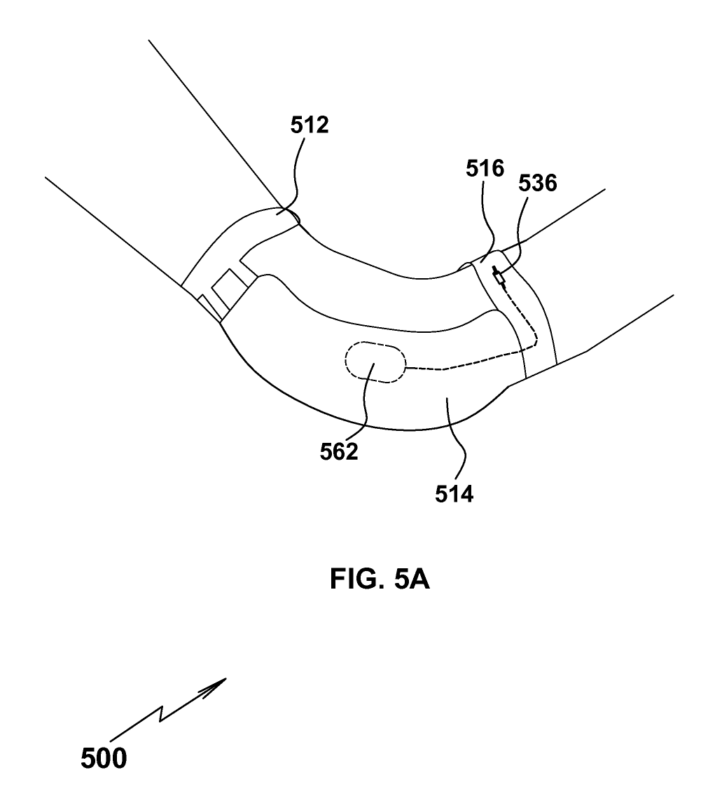

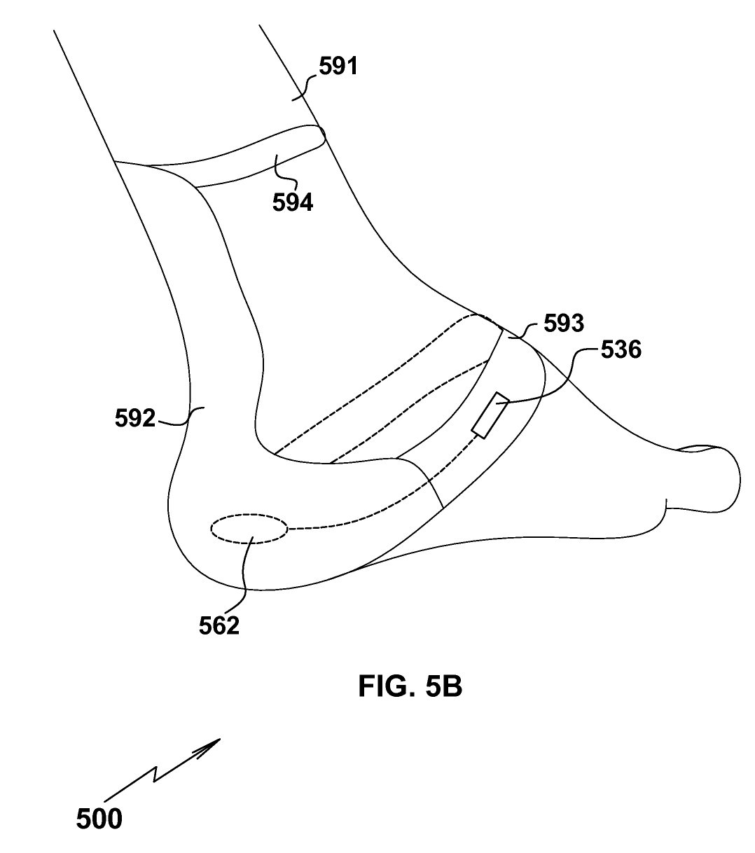

FIG. 5-A shows the arm of a musician with the sensor mounted on the elbow which is easily activated by hitting the elbow on any hard planar surface, shown here complete with Upper Securing Member 510, Elbow sensor support 514, Lower securing member 516. The sensor can also be a pressure sensor or force sensor resistor instead of the tactile switch such that it is not necessary to hit the elbow against a planar surface as the sensor can be activated by pushing against a planar surface instead of impact hit. It is a sensor primarily for pressing and secondarily for hitting. This is analogous to the original natural movement that most percussionists are used to bend or stretch the skin of the playing surface to modulate the acoustic pitch and/or sound.

FIG. 5-B depicts the mounting of a sensor on the heel of the right foot, shown here complete with Heel or ankle Sensor and support 562, Upper securing member on leg 591 and Lower Securing member on foot 592.

This embodiment typically includes a piezo pressure transducer on the arch of the right foot for simulating bass drum sound. Typically either all of the embodiments are wired or wireless as mixing the two is not desirable. In the wireless option each sensor also includes its own self-contained transmitter just like self contained battery.

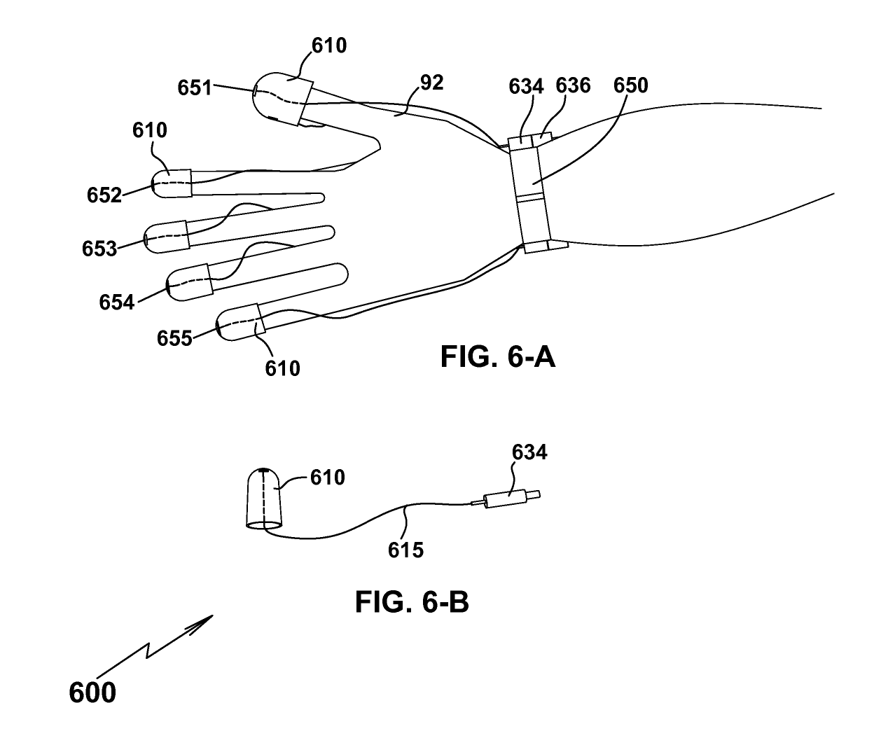

FIG. 6 delineates the location of sensor on a finger with a finger cap instead of the loop of FIG. 4 shown here complete with hand finger caps 610 and sensors at the tips of thumb 651, index finger 652, middle finger 653, ring finger 654, and little finger 655. Connector (Male) 634, Interconnection Bracelet or module 635, Female connector, where in more specifically FIG. 6 consists of two sub-FIGS. 6-A and 6-B as follows.

FIG. 6-A shows the hand with the sensor and finger cap on index finger and a wired connection to a connector mounted on the bracelet on the wrist of the musician.

FIG. 6-B shows in greater detail the finger cap, sensor, connector and a wired connection between the sensor and the music module. The male and female connectors may be interchanged without nay degradation in performance with the aid of convertors which can convert one kind of connector male or female to the other type.

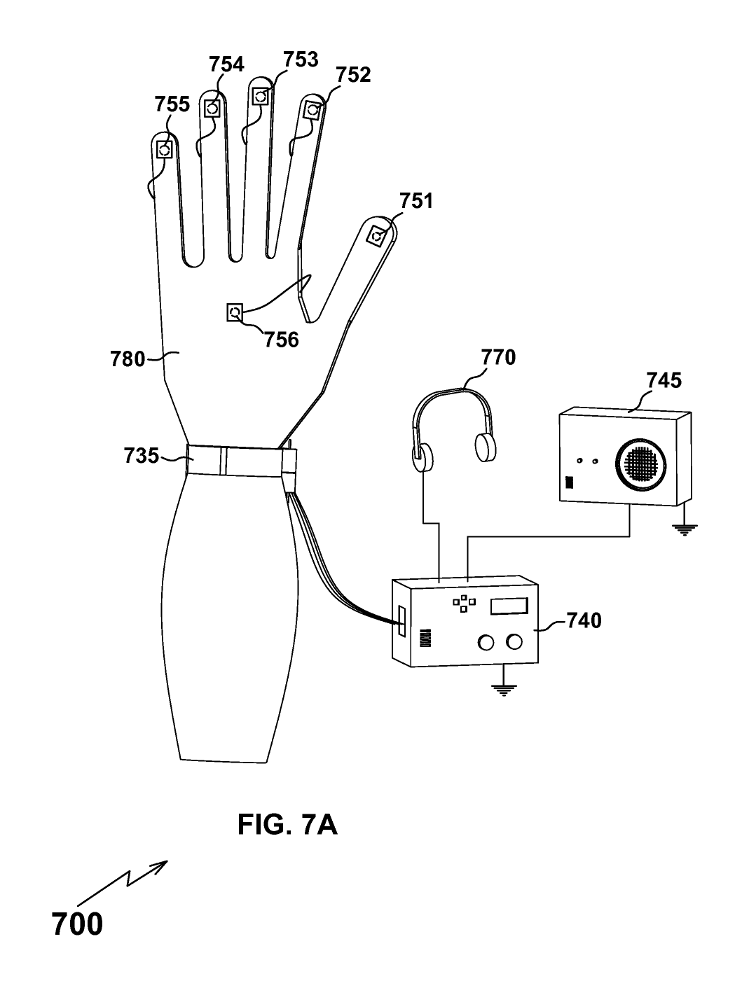

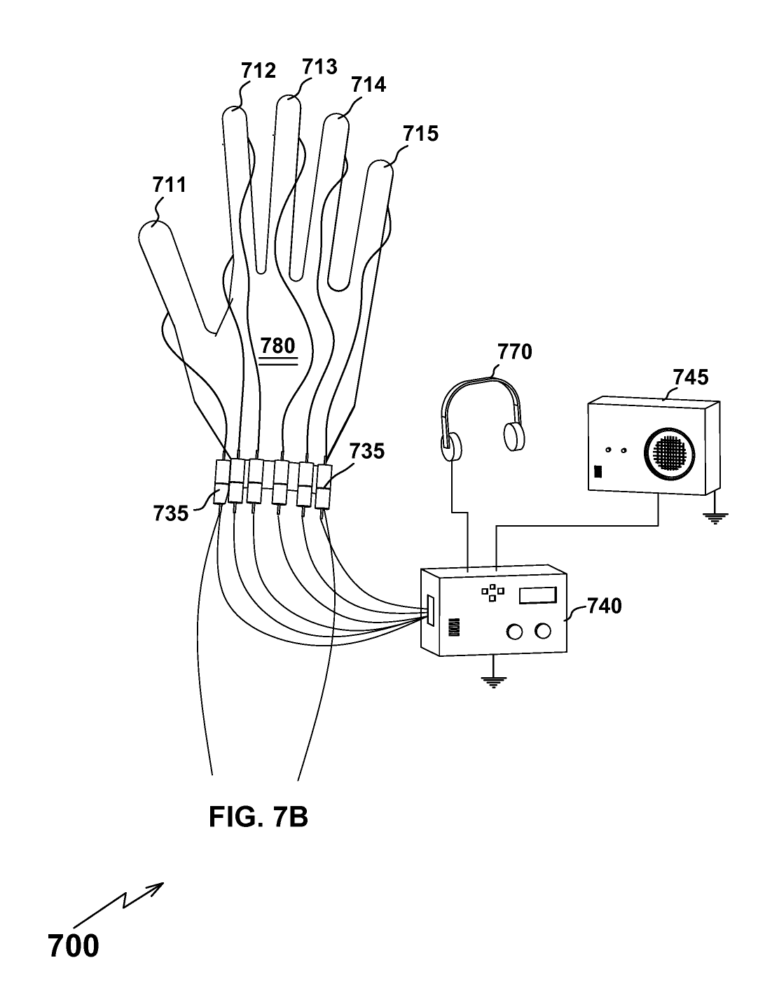

FIG. 7 shows the glove embodiment complete with Male connector 734, Inter Connection Bracelet or Module 735, Female connector 736, Music module sensor connector via Bracelet connection module 739, Music module 740, Amplifier 745, Thumb sensor and support 751, Index Finger sensor and support 752, Middle Finger sensor and support 753, Ring Finger sensor and support 754, Little Finger sensor and support 755, Sensor in palm 756, Headphones 770 and Glove 780 which acts as sensor support for individual sensors on fingers.

More particularly FIG. 7-A shows the glove embodiment with plurality of sensor(s) one for each finger, a sensor on the palm and a force sensor resistor on the base of the palm and a bracelet on the wrist for facilitating connection for music module which is shown further with interface to amplifier, speaker, head phones etc. Likewise more specifically FIG. 7-B shows the back side of the Gloved hand of FIG. 7-A

### Cymbal Choke Effect

FIG. 8 shows the protocol for playing the cymbal creation and snubbing (arresting, stopping halting, interrupting, choking muting or the like) effect like a LIVE conductor would do in a concert except here it is done with only one hand and that too without any orchestra, wherein more particularly

A piezo transducer is mounted on the left side of the band while the tactile switch is mounted on the right side of the band. The stereo cable with stereo jack connected to them so when the piezo is hit it gives the cymbal sound as stored in sound module.

When the piezo is struck or otherwise impacted the pressure is converted into an electrical voltage and is sent to the electronic pre-amp and sound module. The player controls impact mode, orientation and timing etc. by squeezing in between his palm and index finger the tactile switch which immediately stops the signal which in turn and stops the sound of the cymbal sound from the sound module.

The cable and jack cannot be mono. If it's mono then only one of these sensors could be in use. Otherwise only the cymbal initiation or only the tactile switch for stopping the cymbal music can be used. That is why it has to be stereo. Stereo cable is two wires in one sleeve and is divided like a Y configuration.

This alternate embodiment more particularly illustrates the protocol for Cymbal Choke Effect. This embodiment consists of three subfigures (8-A+8-B+8-C) which is shown here complete with thumb sensor and support 811, index finger sensor and support 812, middle finger sensor and support 813, ring finger sensor and support 814, little finger sensor and support 815, stereo sensor cable 821, male connector 834, interconnection bracelet 835, Female connector 836, Pressure sensor 862 mounted on outside of thumb for initiating cymbal sound(s) and Tactile sensor 864 on underside of thumb for halting cymbal sound(s).

More particularly FIG. 8-A shows a perspective view of a hand in partially fisted (and hence partially open also) position. This figure also shows two sensors, a pressure sensor positioned on the outside of the thumb for initiating the cymbal sounds and a tactile switch positioned on the underside of the thumb such that if a fist is made then the contact of the thumb sensor with the index finger triggers this sensor to arrest the sound of the cymbal suddenly, abruptly and sharply. Likewise FIG. 8-B shows the two sensors on a loop-able band with a Piezo pressure sensor on the left side of the band or strap and the tactile sensor switch on the right side of the same band and the two wires are connected to a connector which for ease of connection is male on both ends. Similarly FIG. 8-C shows the same strap of FIG. 2-B shown curved as it will be looped around the thumb such that the piezo pressure sensor ends up on the outside of the right hand thumb and the tactile trigger on the underside of the thumb.

The inventor invented this system with enough mix and match flexibility that other applications become obvious as for example the system is also adoptable for dancers. The whole foot may be covered with sound transducers and sensors like a sock (not shown) which would be used by the dancers.

The sensor caps for the frontal part of the foot, like a frontal half of the sock that is carrying sound transducers of all kinds, like a piezo, Force Sensor Resistors, even gyroscopes and accelerometers all provide added flexibility to custom design the system for specific objectives such as user friendliness, cost effectiveness, durability, portability and all types of other desirable design criteria. How amplifying the front part of the foot pressure switch with one or more sensors of different kind can be achieved in this manner. The extent of mix and match permutations and combinations is limited only by the imagination of the design engineer.

### Use & Operation

The operation and use of Wearable Trigger Electronic Percussion Music System is simple and even intuitive. The device operates all the benefits of a as a drum kit but without the expense and bother of a drum kit. The Wearable Trigger Electronic Percussion Music System process is also equally simple. The novel and non-obvious improvements are contained within the device.

A ‘Do-It-Yourself’ process of creating live music in real time without the use of musical instruments comprises following steps.
1. Mounting at least one sensor on at least one limb of a musician by at least one mounting means to create music of at least one musical instrument.
2. Interfacing said sensor(s) with an electronics and music module.
3. Selecting at least one musical instrument is from a group consisting of percussion, key, wind and string instrument.
4. Further selecting the percussion instrument from a group consisting of bass drum, snare drum, tom toms, cymbals, Hi-Hat control, Conga and Tabla.
5. Storing the sounds of the selected musical instrument(s) in the music module.
6. Interfacing the output of said electronics and music module to an audio output device.
7. Creating music by actuating one or more sensor(s) on one or more limb(s) of music student or enthusiast against any hard planar surface.
8. Selecting at least one sensor from a group consisting of tactile, piezo pressure, pressure sensitive film, force sensor resistor, accelerometer, micro-arduino and micro-gyro.
9. Selecting a mounting means selected from a group consisting of loop means, strap means, band means, cap means, film means, glove means, mitten means, elbow means, ankle means and heel means.
10. Mounting the selected sensor(s) on a limb selected from a group consisting of finger, palm, thumb, toe, foot, elbow, ankle, heel, head and back.

In this The Do-It-Yourself’ process of creating live music in real time a percussion instrument is selected from a group consisting of bass drum, snare drum, tom toms, cymbals, Hi-Hat control, Conga and Tabla. Furthermore cymbal choke effect can be simulated by use of a pressure sensor mounted on the outside of the thumb and a tactile sensor mounted on the underside of said thumb. The cymbal choke effect is initiated by actuating the pressure sensor with momentary impact of the outside of the thumb against any planar hard surface and the sound is choked and snubbed by making a fist such that the tactile sensor is actuated as it is pushed against the index finger of said fist.

The user wears on (straps on) any other of the wearable musical garments: gloves, finger straps (rings), finger caps, foot straps or heel and elbow strap. (Connects it (with cable or wireless) to the drum module, sound module midi sequencer or any midi apparatus which could serve to transform the signal into information which could be used with Virtual studio technology. Connected properly one can listen to the sound via headphones or by some amplifier and speakers)

The user touches or hits any harder surface with a part of his body where the wearable drum trigger is placed. The signal picked up by a sound transducer placed inside the wearable material sends the signal to the appropriate sound module via cable or wirelessly where it becomes the sound of an instrument or its part that the user wanted to hear.

The user can play the complete drum set if he puts the wearable drum triggers on his hands and feet's. The elbow strap serves for properly imitating conga dampening skin effect and other percussive and non percussive instruments and techniques. Any of the sound transducers, like for example foot strap with a tactile switch, could be used as a switch to change programs or sound banks in drum and sound module

One can use wearable drum triggers to play piano sounds through midi interface equipment and VST instruments. He could use the tactile switches in his foot and heel straps as a octave changer for the finger straps or caps or as a modulation tool. Since we can use only five tones with five fingers. Any of the wearable triggers may have a different role, depending on the users musical equipment and musical wishes. For example the fingers of the hand can serve as different drum elements which are usually played with hands or drumsticks (snare drum, tom toms, cymbals etc. . . . ) while the foot straps can serve as bass drum and hi-hat pedal which is the traditional drum setup.

### Hi-Hat Control

The Hi-Hat open closed sound control is performed between the sensor carrier on the arch of the left foot (FIG. 3-B) with a tactile switch or FSR (Force Sensor Resistor) and a piezo pressure sensor on one of the fingers of one hands, typically right hand. This cable with male jack is plugged into the music module instead of a drum module's receptacle. Likewise the hand finger sensor is plugged into the jack specified for a hand Hi-Hat sound. The module then controls and interconnects the signals while playing. Thus the player plays the Hi-Hat sound with his hand sensor and controls the open/closed sound of Hi-Hat cymbals by raising the arch of the left foot.

One can easily use while practicing, composing, working on his creations in at home by the computer or on the road with a portable module as a standalone module or other adequate equipment like portable computer or mobile phone computer or any appropriate piece of equipment with midi interface option. The wearable drum triggers could be used with any part of the equipment (standalone or midi interface) as long as it does not leave the general idea of the invention.

Analogous to stretching the drum skin while applying a pressure can be done with base of a palm instead of elbow. It could be done with the FSR-force sensor resistor or a pressure sensor placed at the base of the palm. A piece that could connect to the palm (piezo) sensor and a bracelet as shown in FIG. 3-A

### Cymbal Choke Effect

FIG. 8 shows the protocol for playing the cymbal creation and snubbing (arresting, stopping halting, interrupting, choking muting or the like) effect like a LIVE conductor would do in a concert except here it is done with only one hand and that too without any orchestra, wherein more particularly

A piezo transducer is mounted on the left side of the band while the tactile switch is mounted on the right side of the band. The stereo cable with stereo jack connected to them so when the piezo is hit it gives the cymbal sound as stored in sound module.

When the piezo is struck or otherwise impacted the pressure is converted into an electrical voltage and is sent to the electronic pre-amp and sound module. The player controls impact mode, orientation and timing etc. by squeezing in between his palm and index finger the tactile switch which immediately stops the signal which in turn and stops the sound of the cymbal sound from the sound module.

Many other alternate embodiments and variations are anticipated. As for an example Both the pressure sensor at the base of the palm and the cymbal “choke” option trigger switch may also be incorporated into the gloves embodiment also or a different limb may be used than those used and illustrated here by this inventor in various embodiments to create the same music. With a little bit of creativity and ingenuity almost any limb can be used for any music or dance especially latest fad or craze dances.

With reference to the above description then, it is to be understood that the optimal dimensional relationships for the parts of the invention to include variations in size. materials, shape, form, function and mode of operation and assembly as well as use are deemed readily apparent and obvious to one skilled in the art and all equivalent relationships to those illustrated in the drawings and described in the specification are intended to be encompassed by the present invention.

Therefore the foregoing is considered as illustrative only of the principles of the invention. Further since numerous modifications and changes will readily occur to those skilled in the art it is not desired to limit the invention to the exact construction and operation shown and described” and accordingly all suitable modifications and equivalents may be resorted to˜ falling within the scope of the invention

### Anticipated Variatios for Alternate Embodiments

The inventor has given a non-limiting description of this invention. Due to the simplicity and elegance of the design of this invention designing around it is very difficult if not impossible. The concept of wearable trigger electronic percussion music system disclosed here would be difficult to design around. Nonetheless many changes may be made to this design without deviating from the spirit of this invention. Examples of such contemplated variations include the following:
1. The value and the tolerance of various electronic components may be modified.
2. The wearable triggers may be built with newer materials, technologies and processes as they become available.
4. Any number and any type of sensors may be mounted on in any orientation in or on any don able flexible material of any type to fit a body limb such as hand, fingers, foot tow, arm leg ankle, elbow, even head and torso and seat.
5. The electronic PCB and its conductors can be made of different materials as they become available due to the technological progress in polymer chemistry.
6. Additional complimentary and complementary functions and features may be added.
7. A more economical or an upscale version of the device may be adapted.
8. A music module to simulate any kind of music may be incorporated as sky is the limit in each type of musical instrument including percussion, string, wind, etc.
9. Some of the hardware components such as pre-amps and amplifiers etc may be realized by equivalent firmware or software.
10. Instead of parallel signals with plurality of lines a single a serial line may be used to bus signals from sensors to music module to amplifier to speakers etc.
11. Analog to Digital conversion may be employed deemed cost effective for an application.
12. Donnable garments in the form of gloves or rings could also be used for additional purposes. For example, drumstick strikes on a drum or cymbal could be imitated, and the hand worn device could also be used to provide inputs characteristic of keyboard instruments or even for data entry or game playing.
13. Regarding the sound transducer carriers: gloves, finger strap rings, finger caps, foot strap, heel and elbow sound transducer carrier; well, the material used in making them can vary in thickness, texture, elasticity, color, size and like parameter variation.
14. Many different kinds of sound transducers and their sizes could be used (piezo film, piezo transducer, force sensor resistor, tactile switches etc.) in any orientation, in any permutation and combination of sensors, limbs, mounting means etc.
15. Flex sensors, gyroscopes and accelerator may be affixed onto any sensor support means in any combination with the other sound transducer(s) to create more complex sound effects.
16. The sensor caps for the frontal part of the foot, like a frontal half of the sock that is carrying sound transducers of all kinds, like a piezo, Force Sensor Resistors, even gyroscopes and accelerometers may be used. How amplifying the front part of the foot pressure switch with one or more sensors of different kind can be achieved in this manner.
17. The system may also be adapted for dancers. The whole foot may be covered with sound transducers and sensors, like a sock or mitten (not shown) which would be used by the dancers for contemporary fad craze dances such as Break dance, Moon walk, Hip Hop, Achy Breaky and the like.
18. A different limb may be used than used by this inventor in various embodiments to create the same music. With a little bit of creativity and ingenuity almost any limb can be used for any music or dance especially latest fad or craze dances.
19. Analogous to stretching the drum skin while applying a pressure can be done with base of a palm instead of elbow. It could be done with the FSR-force sensor resistor or a pressure sensor placed at the base of the palm. A piece that could connect to the palm (piezo) sensor and a bracelet as shown in FIG. 3-A
20. Likewise the sound transducers may be mounted on their carrier at any place and in any number in any orientation.
21. A small tactile switch between the thumb and index finger or any sound transducer at any position on the carrier may be used.
22. Female and male mono and stereo jacks may be used in any permutation and combination in any mating sizes.
23. Likewise cables of any type may be used in the same mix and match attribute as long as it can serve the purpose of transferring the signal blinded, curly, mono, stereo. Any size is possible. Preferably thinner and lighter. All these parameters are viewed by the inventor as design choice(s)
24. Any wireless connection may be employed as long as it transmits and receives the signal or the information. To provide even greater mobility ‘Blue-Tooth’, mobile phones or smart phones interface may be employed.
25. The drum module does not have to be a stand alone drum module but it can be a sound module, midi equipment, midi sequencer connected to the appropriate equipment with software and sound banks it's possibilities are endless.
26. One can play the piano or any other instruments using wearable drum triggers with the computer along with midi interface instead of stand alone drum module (or even together with drum module). One can connect it any appropriate electronic and musical apparatus as long as it does not leave the scope and purpose of an invention.
27. A midi interface box may be mounted onto or near to the each of the drum trigger carriers, further connected to the computer which may be portable, non portable, mobile phone computer, as long as it communicates with the carrier.
28. Velcro leg and hand strap, band loop, can be made from any kind of material or tissue.
29. Connective bracelet material, design and housing in may be varied as long as it does not leave the scope and purpose of the invention.
30. Any appropriate material cloth, tissue, polymer, can be used in designing this invention.
31. Any of the wireless equipment may optionally be backed up by it's own power source battery etc.
32. Piezo transducer or some other sound transducer is connected to the proper electronic connective device with a wireless transmitter (that runs on batteries) which transmits the signal or the information further to the wireless receiver which is a part of a drum module or some other sound module or other appropriate musical equipment.
33. Hybrid wired and wireless environments may be employed.
34. Upscale and downscale embodiments may be designed, manufactured and marketed.
35. Other changes such as aesthetics and substitution of newer materials as they become available, which substantially perform the same function in substantially the same manner with substantially the same result without deviating from the spirit of the invention may be made.

### REFERENCE NUMBER CONCORDANCE

Following is a listing of the components uses in this embodiment arranged in ascending order of the reference numerals for ready reference of the reader.
001=Thumb
002=Index Finger
003=Middle Finger
004=Ring Finger
005=Little Finger
010=Hand
012=Palm
015=Elbow
020=Foot
022=Toes
025=Heel/Ankle
080=Glove
085=Mitten
090=Musician
091=Leg
095=Stool/Chair
099=Logic &/or Power Ground
100=Embodiment of FIG. 1 generally
110=Hand Sensor and Loop
115=Elbow sensor support member
120=Foot Sensor and Loop
125=Heel/Ankle Sensor support
130=Finger Sensor support with loop, strand, band, ring, cap etc.
135=Interconnection Module generally mounted on a bracelet worn on the wrist.
140=Electronics and Music module
145=Amplifier
160=Sensor generally
161=Accelerometer
162=Piezo pressure sensor
163=Thin film pressure sensor
164=Tactile sensor
165=Gyroscope as a sensor
166=Force Sensor Resistor
168=Micro-Arduino
190=Foot loop for wireless interface
192=Wireless I/F on foot loop
200=Embodiment of FIG. 2 generally
220=Pressure transducer
235=Interconnection module configured on a bracelet
240=Music module
245=Amplifier
255=Wireless Transmission Interface
265=Wireless Receiver Interface
272=Headphones with wireless receiver interface
275=Loud Speakers with wireless receiver interface
300=Embodiments of FIG. 3 generally
320=Foot Loop for wireless interface
322=Wireless Interface on Foot Loop
334=Male connector
335=Inter Connection Bracelet or Module
336=Female connector
340=Music module
345=Amplifier
350=Force Sensor Resistor and support in the palm
351=Thumb sensor and support
352=Index Finger sensor and support
353=Middle Finger sensor and support
354=Ring Finger sensor and support
355=Little Finger sensor and support
356=Sensor in palm or arch of foot
394=Leg of musician
396=Let Foot of musician for wireless interface
400=Embodiment of FIG. 4 generally
420=Piezo pressure sensor and support
434=Male connector
435=Inter Connection Bracelet or Module
436=Female connector
470=Band Loop or strap used as sensor support
494=Hook Velcro®
495=Fastener generally eye and hook matching type
496=Eye Velcro®
500=Embodiment of FIG. 5 generally
510=Upper Securing Member
514=Elbow sensor support
516=Lower securing member
536=Female connector
562=Heel or ankle Sensor and support
591=Leg
592=Heel/Ankle sensor support
593=Lower securing member
594=Upper securing member
600=Embodiment of FIG. 6 generally
610=Finger caps or loops
622=Index Finger sensor and support
626=Sensor in Palm with loop support
634=Connector (Male) on connecting module
635=Interconnection module typically an ornamental bracelet
636=Female connector on connecting module sometimes in the form of bracelet
651=Thumb sensor
652=Index finger sensor
653=Middle finger sensor
654=Ring Finger sensor
655=Little finger sensor
700=Embodiment of FIG. 7 generally
711=Thumb sensor
712=Index finger sensor
713=Middle finger sensor
714=Ring Finger sensor
715=Little finger sensor
734=Male connector
735=Inter Connection Bracelet or Module
736=Female connector
739=Music module sensor connector via Bracelet connection module
740=Music module
745=Amplifier
751=Thumb sensor and support
752=Index Finger sensor and support
753=Middle Finger sensor and support
754=Ring Finger sensor and support
755=Little Finger sensor and support
756=Sensor in palm
770=Headphones
780=Glove
800=Embodiment of FIG. 8 generally
811=Thumb sensor and support
812=Index Finger sensor and support
813=Middle Finger sensor and support
814=Ring Finger sensor and support
815=Little Finger sensor and support
821=Stereo sensor cable
834=Male connector
862=Pressure sensor mounted on outside of thumb for initiating cymbal choke effect
864=Tactile sensor on underside of thumb for halting cymbal choke effect

### DEFINITIONS AND ACRONYMS

A great care has been taken to use words with their conventional dictionary definitions. Following definitions are included here for clarification.
3D=Three Dimensional
Bongo(s)=One of a pair of small tuned drums played by beating with fingers.
Conga(s)=A tall conical Afro-Cuban drum played with hands.
Cymbal=A concave plate generally of brass or bronze that produces a sharp ringing sound when struck, which may be played either in pairs by being struck together or singly by being struck by a drumstick or the like object.
DIY=Do It Yourself
Finger Caps)=Thimble of sewing trade that is adapted as musical trigger with incorporation of a trigger sensor.
FSR=Force Sensor Resistor
Hi-Hat Cymbals=A pair of cymbals (typically concave plates of brass) mounted on a rod so that the upper cymbal can be lifted and dropped or released on the lower cymbal by means of a foot pedal.
IC=Integrated Circuit
I/O=Input and Output
Integrated=Combination of two entities to act like one
Interface=Junction between two dissimilar entities
LED=Light Emitting Diode
PCB=Printed Circuit Board
Piezo=One type of pressure sensor or transducer
Pixel=Smallest/finest resolution on a display.
Planar=Any rigid playing surface which in conjunction with wearable sensors produces the music of a variety of percussion instruments of various types from various countries and cultures including but not limited to Congas, Tablas, Cymbals, Table top, counter top, desk, table or the like surface of almost any rigid plastic or metal.
Sensor(s)=any transducer to which when pressure is applied produces sound of a musical instrument (in cooperation with a music module) such as Bass, Snare, Tom Toms, Cymbals, Hi-Hat Controls, Tabla, conga or any other percussion, string or wind musical instrument. Examples of such sensors and transducers include but are not limited to Piezo Pressure Sensor, Tactile Impact switches, Force Sensor Resistors, even gyroscope(s) and accelerometer(s) or the like.
Symmetrical=The shape of an object of integrated entity which can be divided into two along some axis through the object or the integrated entity such that the two halves form mirror image of each other.
Tabla=An Indian musical percussion instrument played with hands and fingers tapping on a small drum tuned to different pitches
VELCRO=A trademark for fibrous detachable fasteners

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within the true scope of this invention. What is claimed as being new and non-obvious and worthy of protection by United States letters PATENT is as follows.

The inventor claims:

1. A ‘Do-It-Yourself’ process of creating live music in real time without the use of musical instruments comprising the steps of:
a) mounting at least one sensor on at least one limb of a musician by at least one mounting means to create music of at least one musical instrument;
b) interfacing said sensor(s) with an electronics and music module;
c) storing the sounds of said musical instrument(s) in said music module;
d) interfacing the output of said electronics and music module to an audio output device; and
e) creating music by actuating said sensor(s) on said limb(s) of said musician against any hard planar surface.

2. The Do-It-Yourself’ process of creating live music in real time of claim 1 wherein:
a) said at least one sensor(s) is selected from a group consisting of tactile, piezo pressure, pressure sensitive film, force sensor resistor, accelerometer, micro-arduino and micro-gyro;
b) said limb(s) is selected from a group consisting of finger, palm, thumb, toe, foot, elbow, ankle, heel, head and back;
c) said mounting means selected from a group consisting of loop means, strap means, band means, cap means, film means, glove means, mitten means, elbow means, ankle means and heel means;
d) said musical instrument is selected from a group consisting of percussion, key, wind and string instruments.

3. The Do-It-Yourself’ process of creating live music in real time of claim 2 wherein said percussion instrument is selected from a group consisting of bass drum(s), snare drum(s), tom tom(s), rototom(s), cow bell(s), gong(s), cymbal(s), Hi-Hat control(s), Conga(s) Bongo(s) and Tabla(s).

4. The Do-It-Yourself’ process of creating live music in real time of claim 3 wherein cymbal choke effect is created by use of a pressure sensor mounted on the outside of the thumb and a tactile sensor is mounted on the underside of said thumb.

5. The Do-It-Yourself’ process of creating live music in real time of claim 4 where in the cymbal choke effect is created by actuating the pressure sensor with momentary impact of the outside of the thumb against any planar hard surface and the sound is choked and snubbed by making a fist such that the tactile sensor is actuated as it is pushed against the index finger of said fist.

6. A Wearable Trigger Electronic Music System comprising:
a) at least one sensor(s) mounted on at least one limb(s) of a musician;
b) mounting means connected to said sensor(s)
c) a sound module connected to said sensor(s)
d) storing the sounds of at least one musical instrument in said sound module; and
e) an output device connected to said music module.

7. The Wearable Trigger Electronic Music System of claim 6 wherein said at least one sensor(s) is selected from a group consisting of tactile, piezo pressure, pressure sensitive film, force sensor resistor, accelerometer, micro-arduino and micro-gyro.

8. The Wearable Trigger Electronic Music System of claim 6 wherein said limb(s) is selected from a group consisting of finger, palm, thumb, toe, foot, elbow, ankle, heel, head and back.

9. The Wearable Trigger Electronic Music System of claim 6 wherein said sensor(s) is mounted on said limb(s) means selected from a group consisting of loop means, strap means, band means, cap means, film means, glove means, mitten means, elbow means, ankle means and heel means.

10. The Wearable Trigger Electronic Music System of claim 6 wherein said musical instrument is selected from a group consisting of percussion, key, wind and string instrument.

11. The Wearable Trigger Electronic Music System of claim 10 wherein said percussion instrument is selected from a group consisting of bass drum, snare drum, tom toms, cymbals, Hi-Hat control, Conga(s), Bongo(s) and Tabla(s).

12. The Wearable Trigger Electronic Music System of claim 11 wherein cymbal choke effect is created by use of a pressure sensor mounted on the outside of the thumb and a tactile sensor is mounted on the underside of said thumb.

13. The Wearable Trigger Electronic Music System of claim 12 wherein the cymbal choke effect is initiated by actuating the pressure sensor with momentary impact of the outside of the thumb against any planar hard surface and the sound is choked and snubbed by making a fist such that the tactile sensor is actuated as it is pushed against the index finger of said fist.

14. The Wearable Trigger Electronic Music System of claim 6 wherein interface between said sensor(s), said sound module and said output device comprises a wireless interface.

15. A Wearable Trigger Electronic Percussion Music System comprising:
a) means for electronically generating musical sounds including the sounds of hand percussion instruments;
b) the apparatus being adapted to be worn a hand of a musician;
c) plurality of pressure sensors individually mountable on adjacent the end of fingers on the palm side of the finger so that the pressure sensors will be separately activated by striking a surface with an open, flat hand held in a position for striking a hand percussion instrument;
d) a percussion sensor mountable on a palm above which the fingers of the hand extend, the percussion sensor generating a signal separate from the signals generated by the pressure sensors on the hand, when a surface is struck by an open, flat hand held in a position for striking a hand percussion instrument; and
e) a communications interface for separately transmitting electric signals generated when the pressure sensors and the percussion sensor strike a surface to an electronic processor.

16. The Wearable Trigger Electronic Percussion Music System of claim 15 wherein the percussion sensor is connectable to the electronic processor by the communications interface to generate a bass signal when the electronic processor comprises an electronic music processor.

17. The Wearable Trigger Electronic Percussion Music System of claim 15 wherein the pressure sensor(s) mountable on the fingers and the percussion sensor comprise identical sensors.

18. The Wearable Trigger Electronic Percussion Music System of claim 15 wherein 5 sensors are mounted in a glove one corresponding to each finger.

19. The Wearable Trigger Electronic Percussion Music System of claim 15 wherein the pressure sensors are positioned on rings for mounting on fingers, and the percussion sensor is mountable on a band adapted to encircle the palm.

20. The Wearable Trigger Electronic Percussion Music System of claim 15 wherein the communications interface comprises a wireless interface.

21. The ‘Do-It-Yourself’ process of creating live music in real time without the use of musical instruments of claim 1 wherein at least one said musical instrument is under Hi-Hat Control with a first sensor on a finger of a hand for simulating a percussion instrument and a second sensor in the arch of a foot to emulate foot control pedal of said Hi-Hat control.

22. The Wearable Trigger Electronic Music System of claim 6 wherein a second tactile sensor in the arch of left foot is employed to emulate foot control pedal of a Hi-Hat control.

23. The Wearable Trigger Electronic Percussion Music System of claim 15 wherein a Hi-Hat Control is emulated by a second tactile sensor in the arch of a foot which is opened by lifting said foot and closed by returning said foot to normal floor position to emulate the pedal of said Hi-Hat control.
